(19) United States
(12) Patent Application Publication
(10) Pub. No.: US 2024/0150069 A1
(43) Pub. Date: May 9, 2024

(54) FOLDABLE STORAGE BOX

(71) Applicant: Zhejiang Roushome Products Co., Ltd., Zhejiang (CN)

(72) Inventor: Mengjie WANG, Zhejiang (CN)

(73) Assignee: Zhejiang Roushome Products Co., Ltd., Zhejiang (CN)

(21) Appl. No.: 18/279,208

(22) PCT Filed: Jan. 19, 2022
(86) PCT No.: PCT/CN2022/072746

§ 371 Date: Aug. 29, 2023

(30) Foreign Application Priority Data
Dec. 2, 2021 (CN) 202123011333.9

(51) Int. Cl. B65D 8/00; B31B 50/20; B31B 50/64; B31B 50/68; B65D 21/08

(52) U.S. Cl. CPC B65D 15/24; B31B 50/20; B31B 50/64; B31B 50/68; B65D 15/22; B65D 21/086; B31B 2120/302

(57) ABSTRACT

A foldable storage box has four hard side surfaces in a vertical direction, a soft bottom surface, and a hard support plate that matches the bottom surface and is disposed on the bottom surface. Each of the side surfaces has a non-woven fabric interlayer, and a hard plug board is inserted in the interlayer. At least one pair of the four side surfaces are capable of being folded along a vertical folding axis. Vertical flexible dividing lines are disposed at intersections of the four side surfaces and the vertical folding axis, and the flexible dividing lines confine and isolate the respective hard plug boards in a horizontal direction. The flexible dividing lines are formed by welding two layers of non-woven fabrics in an ultrasonic welding manner.

### BACKGROUND

### Technical Field

The present invention relates to a storage box, and more particularly, to a foldable storage box and a preparation method of this storage box, belonging to the technical field of storage appliances.

### Description of Related Art

In daily life, people usually use various storage boxes to centrally collect and store some scattered items, which not only effectively controls and utilizes a limited space of people's lives, but also makes people's living space environment more tidy and prevents the scattered items from being stacked casually. However, such storage boxes are either high in production cost, such as a storage box made of a plastic or fabric product, or made of ordinary paper packaging boxes that have been used or not used, but the used paper packaging box is either too large or too small in size space, or the used paper packaging box is not conducive to the convenient storage and access of scattered items at any time, or there are undesirable phenomena such as excessively large storage space occupied when not in use. Therefore, to design a foldable storage box is a technical problem to be solved by those skilled in the art.

### SUMMARY

An object of the present invention is to provide a foldable storage box and a preparation method of this storage box, so as to solve the above-mentioned technical problems of the prior art.

The object of the present invention is achieved by the following technical solutions.

A foldable storage box has four hard side surfaces in a vertical direction, a soft bottom surface, and a hard support plate that matches the bottom surface and is disposed on the bottom surface; each side surface has a non-woven fabric interlayer in which a hard plug board is inserted; at least one pair of the four side surfaces are capable of being folded along a vertical folding axis; vertical flexible dividing lines are disposed at the intersections of the four side surfaces and the vertical folding axis, the flexible dividing lines confine and isolate the respective hard plug boards in a horizontal direction; and the flexible dividing lines are formed by welding two layers of non-woven fabrics in an ultrasonic welding manner.

The side surfaces and the bottom surface are connected in a sewing manner; and further, a circle of decorative strips is wrapped around the outer sides of overlapping positions of the side surfaces and the bottom surface, and the decorative strips not only hide the edges of the overlapping positions of the side surfaces and the bottom surface but also strengthen moldings.

An opening portion of the foldable storage box is also covered with a circle of decorative strips, and the decorative strips hide the edge of the opening enclosed by the side surfaces.

A circular hole is formed on one of the side surfaces, and an edge of the hole is reinforced by a metal or plastic part. The circular hole can be used for allowing a finger to be inserted to drag the storage box.

Among the side surfaces, a width of each of the two side surfaces having the vertical folding axis is smaller than or equal to a width of each of the other two side surfaces. Preferably, the bottom surface is square, and the vertical folding axis is arranged on a symmetry axis of the side surfaces.

A lifting ring is disposed on the upper side of the hard support plate and used for lifting the hard support plate out of the storage box.

The opening portion of the storage box is further provided with a cover box.

“Hard”, “flexible” and “soft” in the present invention are relative terms, rather than a limitation to a certain hardness parameter; “flexible” and “soft” refer to “foldable”; and “hard” means “supportable”.

A preparation method of the above foldable storage box includes the following steps:
(1) cutting a side surface material and a bottom surface material;
(2) stacking two layers of the side surface material of the same size together and flattening by a machine;
(3) moving the side surface material at an ultrasonic welding point to ultrasonic welding equipment along a short side direction; corresponding a predetermined position of an ultrasonic welding head to the flexible dividing line; completing the welding process when all the side surface material passes through the ultrasonic welding head;
(4) hollowing out an appropriate position of the side surface material;
(5) sewing the side surface material and the bottom surface material, and welding or sewing two ends of the side surface material to form a box body;
(6) inserting a hard plug board, and sewing an opening portion of the box body; and
(7) installing a hard support plate to form a complete box body.

The technical solutions of the present invention have the following beneficial effects:
(1) the storage box can be folded, stored and transported more conveniently through the folding design;
(2) a plurality of flexible dividing lines is formed at one time by means of ultrasonic welding, which saves time and labor cost compared with traditional sewing methods; and
(3) the non-woven materials are environmentally friendly and economical.

### BRIEF DESCRIPTION OF THE DRAWINGS

FIG. 1 is a schematic structural diagram of the present invention in a use state.

FIG. 2 is a schematic structural diagram of the present invention in a folding process.

FIG. 3 is a schematic structural diagram of a side surface material of the present invention in an expanded state.

FIG. 4 is a schematic cross-sectional view after the side surface material of the present invention is inserted into a plug board, in which symbol references represent the following components: 1—side surface; 2—bottom surface; 3—hard support plate; 4—flexible dividing line; 5—circular hole; 6—decorative strip; 7—hard plug board.

FIG. 5 is a tensile force and elongation curve diagram of an ultrasonically welded non-woven fabric prepared in the present invention.

### DESCRIPTION OF THE EMBODIMENTS

The technical features of the present invention are further described below in conjunction with the specific embodiments.

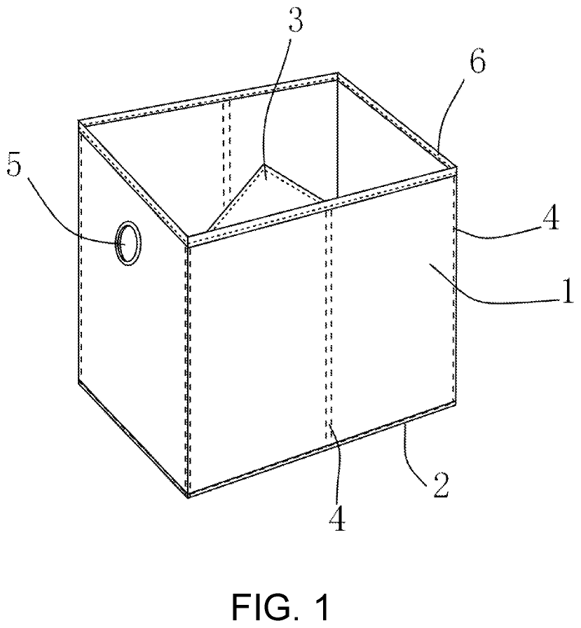

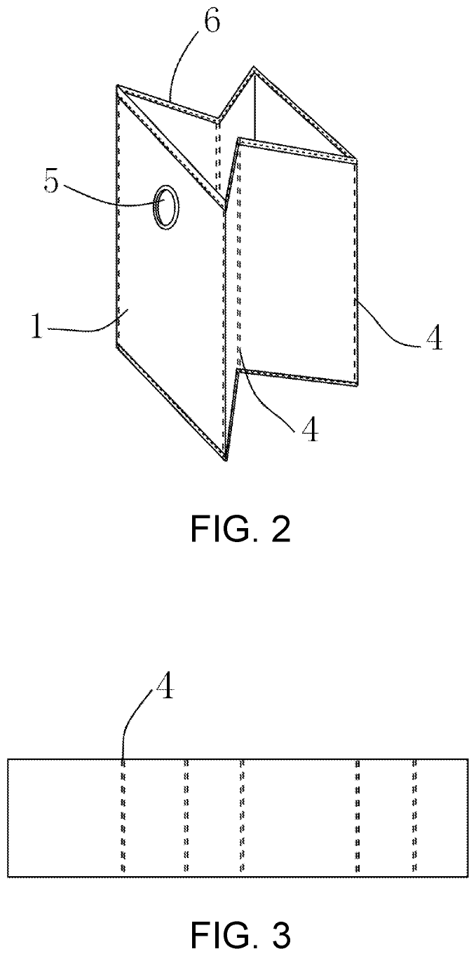

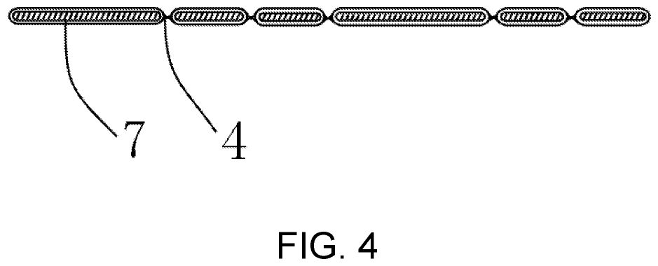

As shown in FIG. 1 to FIG. 4, a foldable storage box has four hard side surfaces 1 in a vertical direction, a soft bottom surface 2, and a hard support plate 3 that matches the bottom surface 2 and is disposed on the bottom surface 2; each side surface 1 has a non-woven fabric interlayer in which a hard plug board 7 is inserted; at least one pair of the four side surfaces can be folded along a vertical folding axis; vertical flexible dividing lines 4 are disposed at the intersections of the four side surfaces 1 and the vertical folding axis, and the flexible dividing lines 4 confine and isolate the respective hard plug boards 7 in a horizontal direction. The flexible dividing lines 4 are formed by welding two layers of non-woven fabrics in an ultrasonic welding manner.

The side surfaces 1 and the bottom surface 2 are connected in a sewing manner; and further, a circle of decorative strips 6 is wrapped around the outer sides of overlapping positions of the side surfaces and the bottom surface 2, and the decorative strips 6 not only hide the edges of the overlapping positions of the side surfaces 1 and the bottom surface 2 but also strengthen moldings.

An opening portion of the foldable storage box is also covered with a circle of decorative strips The decorative strips hide the edge of the opening portion enclosed by the side surfaces 1.

A circular hole 5 is formed on one of the side surfaces 1, and an edge of the circular hole is reinforced by a metal or plastic part. The circular hole can be used for allowing a finger to be inserted to drag the storage box.

Among the side surfaces 1, a width of each of the two side surfaces having the vertical folding axis is smaller than or equal to a width of each of the other two side surfaces. The bottom surface is generally square, and the vertical folding axis is arranged on a symmetry axis of the side surfaces.

A lifting ring is disposed on the upper side of the hard support plate and used for lifting the hard support plate 3 out of the storage box.

The opening portion of the storage box is further provided with a cover box.

A preparation process includes: cutting a side surface material and a bottom surface material; stacking two layers of the side surface material of the same size together and flattening by a machine; moving the side surface material at an ultrasonic welding point to ultrasonic welding equipment along a short side direction; corresponding a predetermined position of an ultrasonic welding head to the flexible dividing line; completing the welding process when all the side surface material passes through the ultrasonic welding head; hollowing out an appropriate position of the side surface material; sewing the side surface material and the bottom surface material, and welding or sewing two ends of the side surface material to form a box body; inserting a hard plug board, and sewing an opening portion of the box body; and installing a hard support plate to form a complete box body.

When in use, the folded storage box is opened by hand, and then the hard support plate is placed on the bottom surface, so that the hard support plate props against the inner wall of each side surface, so as to stretch the storage box and keep the storage box as a cuboid box body. When the storage box is folded, the lifting ring is lifted, such that the hard support plate keeps upright and close to the side surface that does not contain the vertical folding axis. The storage box is then squeezed so that the two side surfaces that contain the vertical folding axis are folded outwards along the vertical folding axis, and meanwhile, the two vertical folding axes are close to each other. In the case that the bottom of the storage box is square, after folding, the two vertical folding axes are close to each other until they touch each other.

The prepared ultrasonically welded non-woven fabric is used for a tensile test as follows:
Sample name: ultrasonically welded non-woven fabric; batch No.: 1;
Test date: 2021-10-12;
Test time: 12:53:21;
Temperature: 25.5° C.;
Humidity: 90% RH;
Operator: Qiu Pingping;
Test form: Tear strength test;
Test type: Regular test;
Tension sensor range: 1000 N;
Clamping length: 100.00 mm;
Width: 100.000 mm;
Tensile speed: 100.00 mm/min;
Thickness: 2.000 mm.

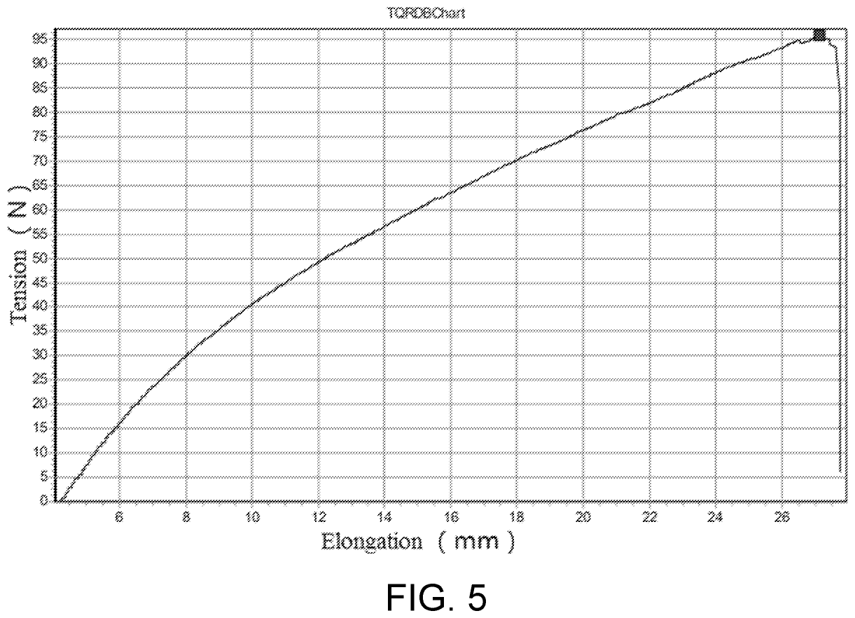

The test results are shown in FIG. 5: maximum strength: 95.83N; maximum elongation: 27.16%; tearing time: 16.06 sec.

Although the embodiments of the present invention have been shown and described, it will be understood by a person of ordinary skill in the art that various changes, modifications, substitutions and modifications can be made to these embodiments, without departing from the principle and spirit of the present invention. The protection scope of the present invention is defined by the appended claims and their equivalents.

1. A foldable storage box, comprising four hard side surfaces in a vertical direction, a soft bottom surface, and a hard support plate that matches the bottom surface and is disposed on the bottom surface, wherein each side surface has a non-woven fabric interlayer, and a hard plug board is inserted in the interlayer; at least one pair of the four side surfaces are capable of being folded along a vertical folding axis; vertical flexible dividing lines are disposed at intersections of the four side surfaces and the vertical folding axis, and the flexible dividing lines confine and isolate the respective hard plug boards in a horizontal direction; and the flexible dividing lines are formed by welding two layers of non-woven fabrics in an ultrasonic welding manner.

2. The foldable storage box according to claim 1, wherein the side surfaces and the bottom surface are connected in a sewing manner; and further, a circle of decorative strips is wrapped around outer sides of overlapping positions of the side surfaces and the bottom surface, and the decorative strips not only hide the edges of the overlapping positions of the side surfaces and the bottom surface but also strengthen moldings.

3. The foldable storage box according to claim 2, wherein an opening portion enclosed by the side surfaces is covered with another circle of the decorative strips, the decorative strips hide an edge of the opening portion formed by the side surfaces.

4. The foldable storage box according to claim 1, wherein a circular hole is formed on one of the side surfaces, and an edge of the hole is reinforced by a metal or plastic part.

5. The foldable storage box according to claim 1, wherein a width of each of the two side surfaces having the vertical folding axis is smaller than or equal to a width of each of the other two side surfaces.

6. The foldable storage box according to claim 5, wherein the bottom surface is square, and the vertical folding axis is arranged on a symmetry axis of the side surfaces.

7. The foldable storage box according to claim 1, wherein a lifting ring is disposed on an upper side of the hard support plate to lift the hard support plate out of the storage box.

8. The foldable storage box according to claim 1, wherein an opening portion of the storage box is provided with a box cover.

9. A method for preparing the foldable storage box according to claim 1, comprising steps:
(1) cutting a side surface material and a bottom surface material;
(2) stacking two layers of the side surface material of a same size together and flattening the two layers by a machine;
(3) moving the side surface material at an ultrasonic welding point to ultrasonic welding equipment along a short side direction; allowing a predetermined position of an ultrasonic welding head to correspond to a flexible dividing line; completing a welding process when all the side surface material passes through the ultrasonic welding head;
(4) hollowing out an appropriate position of the side surface material;
(5) sewing the side surface material and the bottom surface material, and welding or sewing two ends of the side surface material to form a box body;
(6) inserting the hard plug board, and sewing an opening portion of the box body; and
(7) installing the hard support plate to form a complete box body.
